(19) United States
(12) Patent Application Publication
(10) Pub. No.: US 2008/0228867 A1
(43) Pub. Date: Sep. 18, 2008

(54) System and Methods for Synchronizing Data and Media with Third Party Websites and Marketing Materials

(75) Inventors: Matthew W. Murphy, Charlestown, MA (US); Aaron Graves, Boston, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Boston Virtual Imaging, LLC

(21) Appl. No.: 12/019,425

(22) Filed: Jan. 24, 2008

Related U.S. Application Data
(60) Provisional application No. 60/897,198, filed on Jan. 24, 2007.

(51) Int. Cl. G06F 15/16

(52) U.S. Cl. 709/203

(57) ABSTRACT

System and methods for synchronizing data and media with third party websites and marketing materials are disclosed herein. In an embodiment, a form receives data from a client and determines at least two destinations. A central server receives and modifies the data for each destination in such a manner as to ensure compatibility. For each destination, the central server authenticates the client on a local system, authenticates the central server with third party sites via an emulator, sends the data received from the form in a compatible format, and receives a status update from each destination. The central server provides the client with a status for each destination.

### RELATED APPLICATIONS

This application claims the benefit of U.S. Provisional Patent Application Ser. No. 60/897,198, filed on Jan. 24, 2007, which is incorporated herein by reference for the teachings therein.

### FIELD

The presently disclosed embodiments relate to synchronizing data in at least one database, and more particularly to systems and methods for synchronizing data and media with third party websites and marketing materials.

### BACKGROUND

Today, systems are using databases as an effective way to store data. As the internet continues to grow, data is stored within databases in multiple locations. Additionally, corresponding media such as photographs, videos and floor plans are stored within these same multiple locations. For example, in the real estate industry, property listings are found on many websites. If a property listing changes, an industry employee has to log in to multiple sites (e.g., authenticate a user) and manually change the property listing data in multiple locations (e.g., each website having a property listing). One such way a user may authenticate is by using existing software, which allows a user to authenticate with a company network and, in turn, authenticate the user with one or more external sites. The user still must manually update each property listing.

Many websites exist within the real estate industry that display a searchable list of real estate property listings and associated media. Some of these websites are public while others require a subscription. The number of real estate websites today is growing. At the same time, the amount of listing data and media associated with a property listing is increasing due to advances in technology. Listing data refers to textual information about a property, which can be stored in database fields. Examples of listing data include but are not limited to, the price of real estate, square footage, the town or other information describing the property. Media refers to computer files associated with the listing. The media files may be photographs in an accepted format, videos, virtual tour files, audio files, computer generated floor plans, or other suitable media.

Many of the websites that real estate professionals must update do not provide an automated programming interface (API). An API is an interface that a computer system or program library provides to support requests for services to be made of it by another computer program. Because most sites lack an API, the requirement to manually update listings has contributed to an increased workload on the part of the real estate professional and within real estate firms.

Additionally, many real estate professionals use property data and media in order to create marketing materials such as property - specific websites, postcards, flyers and brochures. The layout of these marketing materials is often designed and arranged manually. Any changes to the data and media associated with a listing requires these marketing materials to be manually changed and re-designed.

With a large amount of listing data and media that may be located in many different websites or contained within marketing materials, real estate professionals are having difficulty manually updating the multitude of third party websites and keeping their marketing materials up to date.

Prior systems include U.S. Pat. No. 6,985,902 entitled “Method, System and Apparatus for Creating and Accessing a Hierarchical Database in a Format Optimally Suited to Real Estate Listings;” U.S. Pat. No. 6,883,002 entitled “Real Estate Information Exchange Process and System;” and U.S. Pat. No. 5,884,328 entitled “System and Method for Synchronizing a Large Database and It's Replica.”

Thus, there is a need in the art systems and methods for synchronizing data and media with third party websites and marketing materials to update multiple property listings in multiple databases and for updating associated marketing materials by making a single revision.

### SUMMARY

Systems and methods for synchronizing data and media with third party websites and marketing materials are disclosed herein. According to aspects illustrated herein, there is provided a system for updating a database record in multiple destinations including a form to receive data from a client and determine at least two destinations; a central server configured to receive and modify the data so the data is compatible with each destination; wherein the central server authenticates with each destination, sends the data in the form in a compatible format for each destination, and receives a status update from each destination; and wherein the central server is configured to provide the client with a status for each destination.

According to aspects illustrated herein, there is provided a system to update a database record in multiple destinations including a central server configured to receive data and media from a client and determine at least two destinations, wherein the central server is configured to receive and modify the data and media so the data and media are compatible with each destination; an emulator configured to authenticate the central server with a third party site and send the data and media in a compatible format; wherein the central server is configured to receive a status update from each destination based on the data and media sent by the emulator; and wherein the central server is configured to provide the client with a status for each destination.

According to aspects illustrated herein, there is provided a method for updating a database record in multiple destinations including receiving data and media from a client; providing the data and media to a processing module in a compatible format using a software emulator; determining at least two destinations based on the contents of the data and media; modifying the data and media so the data and media are compatible with each destination; authenticating the client for each destination using the processing module; sending the data and media in a compatible format to each destination; receiving a status update from each destination; and providing the client with a status for each destination.

According to aspects illustrated herein, there is provided a method for updating a database record in multiple destinations including providing a form containing pre-existing data and references to pre-existing media; displaying the form; determining at least two destinations based on the form; modifying the data and media so the data and media are compatible with each destination; authenticating the user for each destination; sending the data and media in a compatible format to each destination; and providing the user with a status for each destination.

### BRIEF DESCRIPTION OF THE DRAWINGS

The present system will be further explained with reference to the attached drawings, wherein like structures are referred to by like numerals throughout the several views. The drawings shown are not necessarily to scale, with emphasis instead generally being placed upon illustrating the principles of the present system.

FIG. 1 is a flow diagram showing an overview of how data and media move from the user to the system and how the data and media are modified and distributed from within the system.

FIG. 2 shows four exemplary types of client requests and provides a description of the general flow of data and media between a client, the system and a third party site.

FIG. 3 shows the handling of client requests within the server process,

FIG. 4 shows the components of the Secure Distributed URL Mapping Layer (SDUML) in the server process.

FIG. 5 is a flow diagram of a password vault module of the system.

FIG. 6 is a flow diagram of a persistent link module of the system.

FIG. 7 is a flow diagram of a templating engine of the system.

FIG. 8 is a flow diagram of a auto fill module of the system.

FIG. 9 is a flow diagram of hash tables of the system.

FIG. 10 is a flow diagram showing an embodiment of a method for updating a database record in multiple destinations.

FIG. 11 is a flow diagram showing an embodiment of a method for updating a database record in multiple destinations.

FIG. 12 shows a block diagram of a representative computer system.

While the above-identified drawings set forth certain embodiments of the present system, other embodiments of the present system are also contemplated, as noted in the discussion. This disclosure presents these illustrative embodiments by way of representation and not limitation. Numerous other modifications and embodiments can be devised by those skilled in the art which fall within the scope and spirit of the principles of the present system.

### DETAILED DESCRIPTION

Systems and methods for allowing multiple users to simultaneously synchronize a database and associated media assets with third party websites are disclosed herein. A software application allows one or more users to simultaneously interact with one or more third party databases. A centralized storage center allows real estate professionals and firms to control their data and media assets. Once the data and/or media are stored, software synchronizes property data and media assets with third party sites. The data may include data and media for real property listings of real estate.

The presently disclosed embodiments allow multiple users to interact with one or more third party web sites and databases. In an embodiment, the system modifies data and media to ensure compatibility of the data and media in the third party site. For example, if a database field is “association fee” and the third party site uses “condo fee,” the “association fee” data is converted to be compatible with the third party site. Additional checks are performed including, but are not limited to, ensuring that the size and type of data are compatible with the third party sites. Modifications to media may include changing the resolution and file size of a JPEG photograph to meet requirements of a third party site 310. A benefit of updating one or more third party web sites is a real estate professional does not have to manually access third party websites and make changes. The real estate professional may use a single interface to update all data and media relating to a property listing.

Additional features include, but are not limited to, built-in flood protection, rate-limiting, and CAPTCHA extraction. Flood protection and rate limiting protect third party sites from processing unnecessary data. Flood protection tracks the frequency of a client request within a given time period. If the number of requests within a given time period exceeds a pre-determined limit of time period, the system filters these requests and does not allow these requests to a third party site. For example, a user is using a form on a website where the form contains a submit button. If the user repeatedly clicks the submit button and exceeds the limit of clicks for a given time period, flood protection could filter out any remaining requests until the average frequency of requests fall below a pre-determined limit (i.e., one click per second).

Rate limiting is similar to flood protection with one distinct difference. Flood protection filters requests that exceed the pre-set limit for a given time period, preventing these requests from reaching the third party site. Rate limiting allows such requests to proceed to the third party site, but it reduces the frequency of the transmission of such requests to the third party site.

In an embodiment, the system uses CAPTCHA extraction to interact with third party sites that employ the use of a CAPTCHA (Completely Automated Public Turing test to tell Computers and Humans Apart). CAPTCHA is a type of challenge-response test used to determine whether or not the user is human. A common type of CAPTCHA requires that the user type the letters of a distorted image, sometimes with the addition of an obscured sequence of letters or digits that appears on the screen. Under circumstances where a CAPTCHA is employed on a third party site, the system displays the CAPTCHA to the user for interpretation. The system then relays the user's response to the third party site, allowing the request between the system and third party site to proceed.

A data synchronization system stores and provides data locally. Data is accessible locally even in the absence of any connection to a central database or failure of a network connection. Synchronization improves response times for data requests. Retrieval rates are faster because requests are processed on a local server without accessing a wide area network. Local processing offloads work from a central database server so that competition for processor time is decreased.

A software system for synchronizing a local database and associated media with one or more third-party web sites is disclosed. A server receives a user authentication information and corresponding data and/or media. Once the user authenticates with the server, the system sends the data and media to one or more third party website without the need for the third party site to be pre-configured with an API (Automated Program Interface). To interact with third-party systems, the system may either emulate a web browser and post the data or provide the user with a submission form having data pre-filled. The criteria which determine the methods of communication with third party sites are contained in individual templates associated with each user, or groups which they may be associated with such as a real estate office location or company. Some third party listings that may use presently disclosed embodiments include, but are not limited to synchronizing real estate listings among various newspapers, online fora, electronic listing services, and other listings. Some benefits include system distributing advertisements to various online destinations, amalgamating several subscription-based online resources for students at a university, or creating new meta-interfaces for immutable intranet applications in slow-moving industries, such as banking. The system allows a user to edit data and media through a single interface and ensures that the data and media will be consistent across multiple third party sites. The system removes the burden on the user of manually maintaining several independent systems.

A single entity constructs a secure web interface over existing web systems that are unable to offer proper interoperability. An engine provides synchronizing real estate data with multiple third-party destinations. The engine is comprised of multiple components for synchronizing data such as a templating engine. A templating engine is software that uses regular expressions and a SQL database to securely store and interpret generalized layouts and processes stored in JSON data blocks in real time. JSON (JavaScript Object Notation) is a lightweight data-interchange format. JSON is a text format that is language independent, but uses conventions similar to C, C++, C#, Java, JavaScript, Perl, and Python and other programming languages. JSON may be built on two structures (1) a collection of name/value pairs. In various languages, this is realized as an object, record, struct, dictionary, hash table, keyed list, or associative array; and 2) an ordered list of values. In most languages, this is realized as an array, vector, list, or sequence.

In an embodiment, the system includes a password vault. The password vault provides centralized and secure storage for passwords required by third party sites. The password vault applies passwords to a template so a client's confidential credentials are protected. The password vault is a database that is accessible to a script in the templating engine. Passwords are accessible to templates through the templating engine while restricting the passwords from individual users. Administrators of the system may test and create templates which will use the passwords through substitution without the administrators ever seeing the passwords.

In an embodiment, a server uses persistent links. The persistent link emulates a full-featured web browser, carrying out automated HTTP/HTTPS transactions in a way that replicates the behavior of a web browser including support for web technologies such as javascript and Cascading Style Sheets (CSS). The persistent link interprets requests from an unlimited number of client machines via secure channels and forwards the requests through a single secure channel. The persistent link derives its authentication data from the template engine and the password vault. The persistent link acts as a single sign-on layer, allowing clients to authenticate once with an engine and use centralized login credentials stored in the password vault to access third-party sites without the individual user's knowledge of the appropriate passwords.

In an embodiment, autofill software uses a series of associative arrays for storing the relationships between database fields within the database and form fields on third-party web sites. Arrays hold a sequence of data elements, usually of the same size and data type. Individual elements are accessed by their position in the array. The position is given by an index, which is also called a subscript. The index usually uses a consecutive range of integers, but the index can have any ordinal set of values. Some arrays are multi-dimensional, meaning they are indexed by a fixed number of integers. A vector/list (for one-dimensional arrays), a matrix (for two-dimensional arrays), or other suitable memory may be used to store data elements. In an embodiment, the system uses these arrays with the persistent link module and populates form fields with data stored within the system. The data population is done in real time. The data has been converted so that it conforms to the constraints of a third party site. Conversions may include changing the database field name and modifying the size and type of data being sent to the third party site. As a result, a user receives third party forms that are pre-filled with data from the system that conforms to the constraints of a third party site. Once the user receives the form, the form may be submitted from the user's machine to the third party site.

In an embodiment, the system uses a plugin. The plugin (or plug-in) is a computer program that interacts with a main (or host) application (a web browser or an email program) to provide a certain process on-demand. In an embodiment, the system uses a browser plug-in as an alternative for the autofill feature. In operation, the system recognizes a third party form and the browser plug-in activates. Once the browser plug-in activates, the browser plug-in prompts a user for a numerical identifier to reference a property listing within the database. The browser plug-in then authenticates the user, retrieves the property listing, and performs an autofill in a form on the user's browser.

In an embodiment, the persistent link software interacts with the autofill software and generates form submissions from a database, renames the fields to use the third-party site's nomenclature, authenticates the user with the third-party site, and submits the data to the third-party site. The system retrieves third-party forms periodically using the persistent link software, and changes are noted by comparing a hash (such as md5) with the existing forms stored on the system. In the event of a change, automated software parses the new page, identifies new fields, and submits them to system administrators for review.

In an embodiment, interactions with third-party sites are logged. The presently disclosed embodiments store a log and make the contents available to the user. The content of such logs may be used to create a history of activity relating to individual listings or a user. It is useful to note that logging interactions allows monitoring of the activity of individual users even when a company shares a single set of authentication credentials on a third party site.

In an embodiment, data can be imported from third party sites by reversing the auto fill and hash table process. Instead of converting the data from the format used by the system to that of a third party site, the system may connect with data on a third party site to populate the database of the system. In this embodiment, the hash tables are used to perform the conversions. The data of the third party site is the original data and a database within the system is the destination. Therefore, a conversion occurs to ensure that the data from the third party site is compatible with the design of the database within the system.

In an embodiment, the system allows an end-user to synchronize data and media from a listing within a database of the system to a third-party site. The third party website does not need to create an automated interface using an Application Programming Interface (API). An API is an interface that a computer system or program library provides to support requests for services to be made of it by a computer program. When interacting with third party sites, the system will mimic the behavior of a human user relative to the third party site. The interaction between the system and a third party site is such that a third party site cannot distinguish between a connection by the system or an actual human user. Thus, the system of synchronizing data between the system and third party sites is an automated process requiring little human interaction.

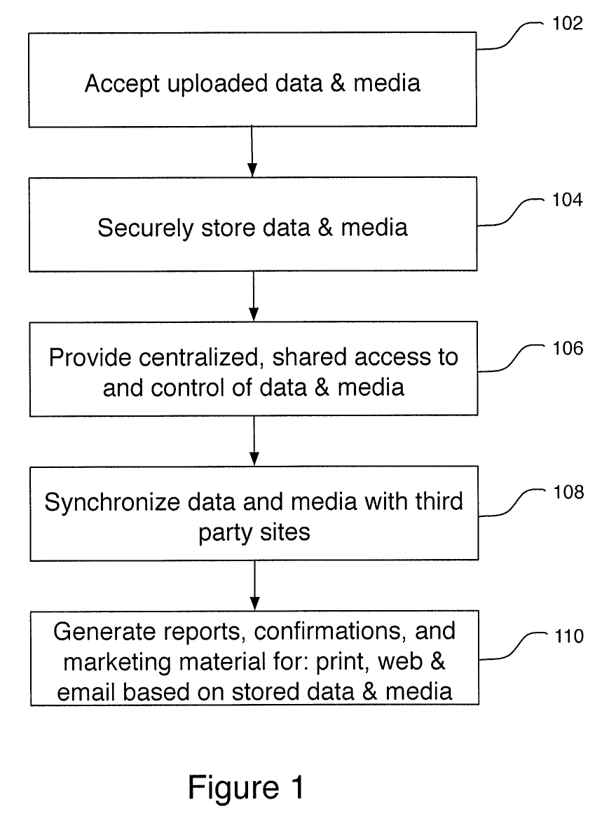

FIG. 1 is a flow diagram depicting a process that accepts, stores, modifies, and processes data and media. The data may relate to real estate listing data. As shown in step 102, the process accepts uploaded data and media from a user. The data may include the textual information which will be stored in database fields relating to an individual real estate listing. The data could also be the price of the property for sale, the square footage, number of bedrooms, number of bathrooms, name, contact information of the listing agent or other information. The property data could include the text descriptions used as advertising copy to entice potential buyers to become interested in the home. The media may include computer files that are associated with an individual property listing and may be used to help with the marketing of the property listing real estate. The media may include photographs in standard formats including but not limited to: JPEG, TIFF, PNG, GIF, videos in formats including but not limited to Flash, Quicktime, Windows media, written documents and floor plans in multiple formats including but not limited to MS Word and PDF, computer files that constitute about 360 degree immersive photography, often referred to as virtual tours, audio files in a format including but not limited to MP3, WAV, and Flash and similar formats or other information.

A process provides a user the feature of uploading data and media to a centralized software application residing on a server. Once the data and media are uploaded, the process securely stores, data and media 104 based on user requests.

As shown in step 104, data and media are stored on a server. The server software has the ability to modify, customize, arrange, and distribute the data and media 104 according to pre-defined user instructions.

The process synchronizes the data and media with third party sites, as shown in step 108. In the real estate industry, there are several different databases and third party sites that display property listing information. These databases generally do not have compatible data and media formats. The user is often required to maintain an awareness of which data and media are contained within each separate third party site. As a result, the process communicates with third party sites and ensures that the data and media contained in the process are represented in an accurate and consistent manner across each third party site relating to a property.

In an embodiment, a software application allows centralized, shared access and control of the data and media by authorized users, as shown in step 106. For example, authorized users could be a group of real estate agents in the same office, an office administrator, or an office manager, or other professionals.

The process generates reports, confirmations, and marketing materials for print, web and email based on stored media and assets, as shown in step 110. The process contains features that allow for the dynamic generation of marketing materials without requiring additional work on the part of the user. Dynamic generation of marketing materials uses the stored data and media as well as software contained in the server process to create the marketing materials. For example, real estate agents often create postcards which are mailed to prospective buyers and sellers. Currently, a user may assemble the design for such postcards using a computer software program designed for such tasks. Currently, the user must possess specialized knowledge of the computer software, experience in the principles of graphic design in general, and know how to access and handle computer files used for generating these postcards. Currently, the user manually arranges elements on a page and incorporates a high level of subjective judgment over placement of elements on the page and other design features. In an embodiment, the system automatically and dynamically assembles the design for a postcard without any user interaction. The system stores instructions in pre-defined templates to establish page layout. The system also incorporates data and media to create the page design with information including but not limited to photographs, contact information, property details, price and similar information. Once the design is created, the design is sent to a printer to be converted to an actual postcard.

Similar marketing materials may also be made such as individual web sites relating to individual property listings or the design for feature sheets. Feature sheets are printed marketing materials containing property information which often exist in paper form and are distributed to potential buyers. The system may also create automated web based slide shows to display the individual still photographs as a packaged presentation or marketing emails delivered to potential buyers.

The system includes the ability to track usage history for activity performed and an interface to allow users to view this history and determine the success or failure of any feature.

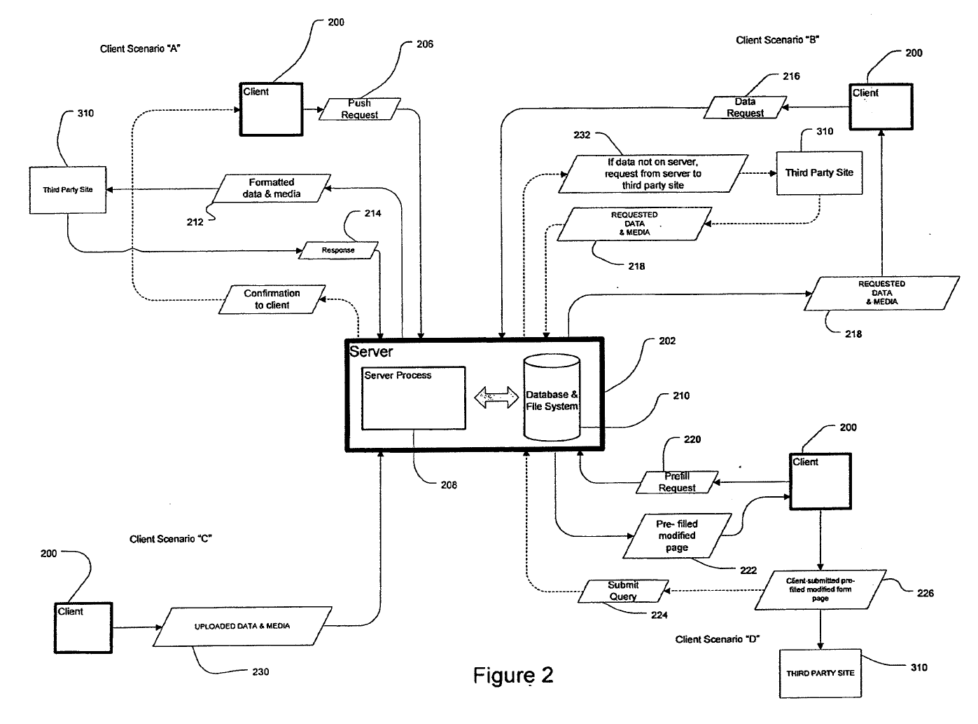

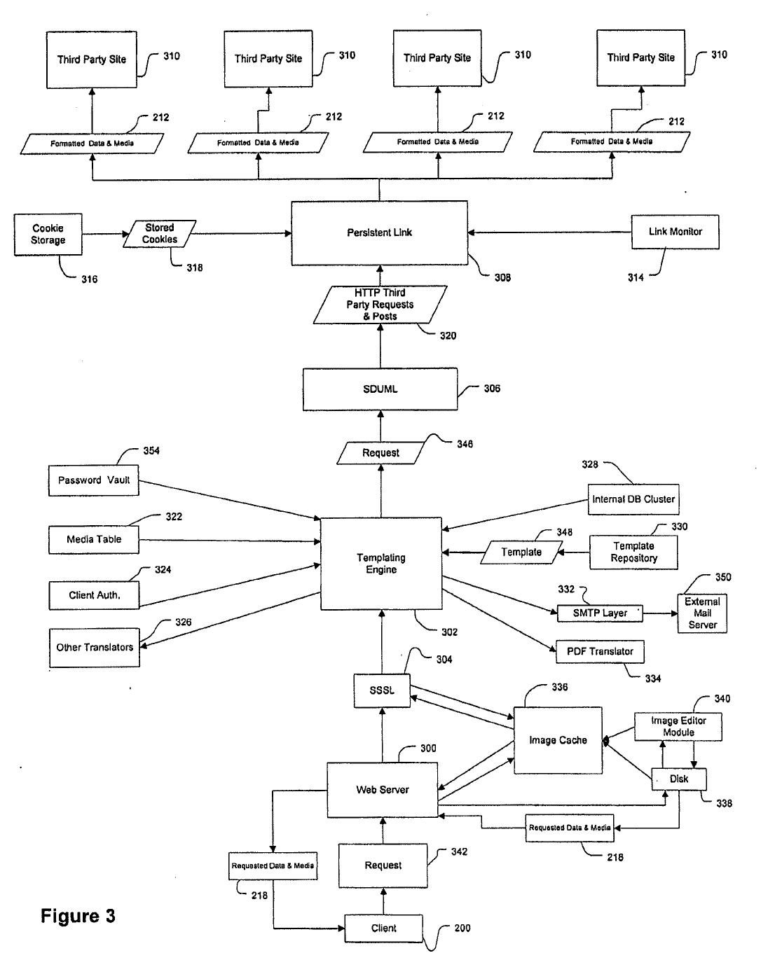

FIG. 2 displays four example embodiments where a client 200 communicates with a server 202 to move data between the client 200, the server 202, and third party sites 310. In an embodiment, the server 202 contains software known as a “server process” 208. The server process 208 analyzes a client push request 206, interacts with the stored data and media, modifies data and media, and communicates with the third party sites 310. An example of the server process 208 is shown in FIG. 3.

In an embodiment shown in Client Scenario A in FIG. 2, the client 200 initiates the push request 206 to the server 202. The server 202 receives the push request 206 and the server process 208 analyzes the push request 206. Next, the server process 208 communicates with a database and file system 210 containing data and media and modifies the data and media so that data and media is compatible with the third party site 310. The server process 208 sends formatted data and media 212 to the third party site 310. The third party site 310 sends a response 214 to the server 202. The server process 208 parses the response 214 from the third party site 310. The server process 208 sends a confirmation to the client 200 indicating a success or failure regarding the push request 206 to the third party site 310. During this process, modifications may occur that include, in the case of data, changing the database field names used by the server process 208 to ensure compatibility with a third party site. In an embodiment, the system modifies data using hash tables which are useful for re-naming and re-formatting data. The hash tables translate data from the system structure to a structure that a third party site recognizes. Modifications to media may include changing the resolution and file size of a JPEG photograph to meet requirements of a third party site 310.

In an embodiment shown in Client Scenario B in FIG. 2, the client 200 requests data from the server 202. A client 200 sends a data request 216 to the server process 208. If static data exists and no analysis or modification is needed, the server process 208 directs the request to the database and file system 210. Next, the server process 208 accesses the stored media based on the type of request. If not, the server process 208 modifies requested data and media based on the type of request. The server process 208 sends requested data and media 218 to the client 200. Examples of requested data and media 218 include but are not limited to HTML, PDF, JPEG, or other suitable data format. If at the time of the data request 216, the requested data and media 218 are not within the server 202, the server process 208 establishes a connection 232 with the third party 310 site and accommodates the data request 216. After the connection 232 is made to the third party site 310, the server process 208 requests data and media from the third party site 310. The server 202 receives the data and media from the third party site 310. The server 202 sends requested data and media 218 to the client 200 without requiring the client 200 to connect to the third party site 310. The request and retrieval of data and media from the third party site 310 to the server 202 is transparent to the client 200.

In an embodiment shown in Client Scenario C in FIG. 2, the client 200 uploads data and media 230 to the server 202. Examples of data and media 230 include but are not limited to photos, text, descriptions, or other suitable data and media. The server 202 stores data in a database and media in the file system 210. Storing data and media in this fashion makes data and media searchable, sortable, accessible and ensure its integrity and quality. Additionally, the structure is easily scalable.

In an embodiment shown in Client Scenario D in FIG. 2, a pre-fill request 220 is used by the client 200 to send data from the server 202 to the third party site 310. If the third party site 310 requests the client 200 authentication (e.g., user name and password), the client 200 is used for authenticating. After authentication is complete, the client 200 requests a pre-filled modified form page 222 from the server 202. The server process 208 generates the pre-filled modified form page 222 and delivers the page 222 to the client 200. The pre-filled modified form page 222 contains data and media in a format which is compatible with the third party site 310. The client 200 then submits the completed pre-filled modified form page 222 to the third party site 310. The third party site 310 receives the pre-filled modified form page 222 from the client 200 submission. In an embodiment, the pre-filled modified form page 222 also contains software that generates a submit query 224 which communicates with the server process 208 upon a client submitted pre-filled modified form page 226. The submit query 224 is a duplicate request sent by the pre-filled form page 222 to the server 202. The form 222 sends the submit query 224 data to the server 202. This submit query 224 is used to confirm that the data and media were submitted by the client 200 to the third party site 310 via the pre-filled modified form page 222. As a result, the server 202 receives the submit query 224 data and stores the submit query 224 data in the database and file system 210. The third party site 310 receives the pre-filled modified form page 222 and accompanying data and media as though they were sent by the client 200 without the server 202.

As shown in FIG. 3, a web server 300 receives a request 342. If the request 342 relates to existing data on a disk 338 or image cache 336, the web server 300 transmits the data from the disk 338 or image cache 336 to the client 200. If the request 342 is the result of a dynamic process such as a script, Server-Side Scripting Language (SSSL) 304 is invoked. The SSSL 304 begins a process according to the rules of its language and transmits the result to the client 200. The disk may include any machine readable medium such as magnetic disk drives, optical disk drives, memory cards or sticks, flash memory devices, that may be accessed locally or remotely via any known means of communication such as WAN, local area network (LAN) via land line, satellite, or other transmission medium.

The system also includes a templating engine 302 which uses one or more template(s) 348. The template(s) 348 include layout instructions in a markup language such as HTML, XML, XHTML, or other markup languages known to those skilled in the art. The templates 348 may also contain references to a local server, resources or scripts such as URLs, and placeholders for information. Further, the templates 348 may contain instructions for the modification or formatting of data and media 212 as well as instructions for how the system should communicate with third party sites 310. The templates 348 may be stored in a template repository 330. For example, the request 342 may be made for the price of an item, the value returned is dependent upon different variables such as the identity of the client, geographical location, time of day, or the presence or content of resources on the third party site 310. For example, if a request originates from the client 200 for a web page, the content of the web page may be created using these variables. A practical example is displaying “good morning” on a web page if the request is received between 5:00 a.m. and 12:00 p.m. local time. In an embodiment, a user may view custom web pages based on templates. For example, if a user is authenticated on the system, a web page displays a name and photograph with the greeting. Similarly, if the server detects the client's geographical location via their IP address, the page may contain information or property listings relating to that geographical location.

If the client 200 requests the result of the templating engine's 302 analysis of the template 348, the templating engine 302 uses a number of resources to produce the requested data for the client 200. During the analysis, the template may use an internal database cluster 328, password vault 354, client authorization components 324, media table 322, PDF translator 334, image editor module 340, or other translators 326. During the client's request 342, the templating engine 302 translates data between formats using hash tables (not shown), sends and receives information from third party web sites 310 and mail servers 350, accesses local authentication data 324, accesses the media table 322, accesses the internal database cluster 328, and translates the output into other formats using the PDF translator 334 or other types of translators 326. Further, the templating engine 302 may access the image editor module 340 to modify image files existing in accepted formats including but not limited to: JPEG, GIF, PNG and TIFF. The templating 302 engine may interact with the image editor module 340 to modify the file size, resolution, aspect ratio, color mode, or to add a watermark, or otherwise modify an image file stored on the server 202. All transactions, including those involving third-party sites 310, are cached using an algorithm which balances the need for “fresh” data, low access times, and efficient disk usage.

The algorithm is a custom algorithm using fuzzy logic to purge the cache of items depending on their score according to the algorithm. For example, the algorithm analyzes items according to different criteria including, but not limited to, file size, creation date, total times the item has been accessed, the date the item was last accessed, and similar criteria. Each item is assigned a score from −1 to 1 for each criterion. For example, an item may have large file size and be scored a 1 for file size, it may have been created in the distant past so it would score a −0.5, it may not have been accessed many times so it would score a −0.7 for the number of times it is accessed, the last time it was accessed may be very recently so it would score higher, possibly a 0.6. These individual scores are weighted and then added together to determine a total score of the item. Cached items with higher total scores tend to remain in the cache, ready for faster retrieval. Cached items with lower scores are judged to be lower priority items and tend to be purged from the cache to free up system resources.

Server Side Scripting Language (SSSL) requests requiring modification to data and media are performed by the templating engine 302. The templating engine 302 accesses and analyzes instructions stored in templates 348. The templates 348 are contained in the template repository 330. These stored templates 348 contain instructions for the manipulation, modification, layout, and distribution of data and media stored on the web server 300.

The instructions contained within the templates 348 and stored in the template repository 330 determine several key actions including the instructions by which the templating engine 302 performs the following: resizes and modifies media from the media table; modifies, converts and formats data from the internal database cluster 328; establishes layout and arrangement of media and data within a visual electronic interface or in printed materials produced by the PDF translator 334 or other translators 326; and interacts with the media table 322, the internal database cluster 328, a Simple Mail Transfer Protocol (SMTP) layer 332, and the PDF translator module 334.

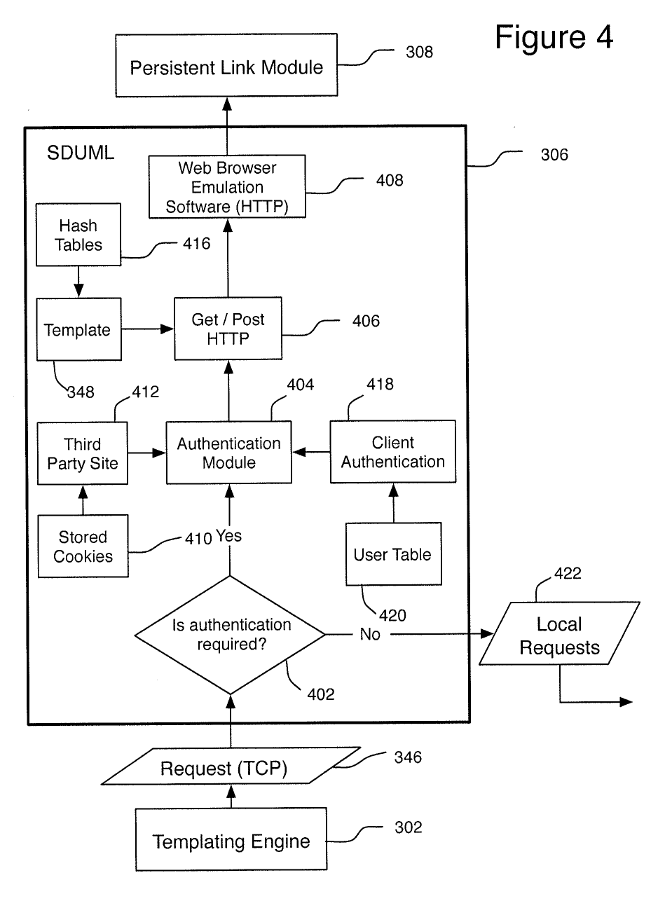

The instructions contained within the template(s) 348 determine how the templating engine 302 interacts with a Secure Distributed URL Mapping Layer (SDUML) 306 and a persistent link module 308 in communication with third party sites 310. If the templating engine 302 determines that a particular request requires interaction from the third party site 310, the request is passed to the SDUML 306. The SDUML 306 determines whether the server process 208 and the client 200 are authorized to communicate data and media between the server 202 and the third party site 310. An example of a SDUML is shown in FIG. 4. If the SDUML 306 module determines that the client 200 is an authorized user, the server process 208 has the proper authentication required by the third party site 310 for a request 346. Next, the SDMUL 306 forwards a third party request 320 to the persistent link module 308. The persistent link module 308 manages the connection between the server process 208 and the third party site 310 requiring authentication. In an embodiment, the persistent link module 308 accesses cookies 318 stored in a cookie storage module 316. The cookies 318 are used to maintain an authenticated session with the third party site. A link monitor 314 maintains the connection to the third party site by periodically sending small amounts of data to maintain the connection or otherwise time out. If the link monitor 314 determines that a session has timed out, the persistent link module 308 reestablishes the connection and initiate a new session. While a session is maintained, formatted data and media 212 may be transmitted between the server and the third party site 310. Instructions contained within the stored templates of the templating engine determine how the persistent link module 314 sends formatted data and media 212 to third party sites 310.

FIG. 4 is a detailed view of the SDUML module 306. The SDUML module receives the request 346 from the templating engine 302 and determines if the request 346 is authorized to proceed to the persistent link module 308 to communicate with the third party site 310.

The SDUML module 306 includes a request router 402 and determines if the request 346 is one which requires authentication. If the request 346 does not require authentication, the request 346 is sent to the web server 300 as a local request 422. If the request router 402 determines that the request 346 requires authentication, the request 346 is passed to an authentication module 404. To send the request 346, the request 346 may use a general-purpose scripting language or a reflective programming language designed for producing dynamic web pages, such as PHP, ASP (Active Server Pages), PERL, J2E or other scripting language.

Request authentication takes place within the authentication module 404. The authentication module 404 authenticates the request 346. First, the authentication module 404 analyzes the credentials of the client 200 who initiates the request 346. The authentication module 404 analyzes a user table 420 of the software application to determine user authentication. Second, the authentication module 404 analyzes stored cookies 410 within a third party site authentication module 412 to determine if the application currently has an open authenticated session with the third party site 310. The third party site authentication module 412 manages stored cookies which determine the authentication status between the system and third party sites. If the third party site authentication module 412 contains valid cookies and the session is valid, the request 346 proceeds. If the cookie within the stored cookies 410 is not valid, the persistent link module 308 establishes the session. If no authentication credentials are stored on the server 202, the request 346 does not proceed.

If the authentication credentials for the third party site 310 and client authentication 418 are valid, the request 346 is converted to either a GET or POST request 406 according to HTTP (Hypertext Transfer Protocol). GET and POST requests are methods of HTTP (hypertext transfer protocol). Both GET and POST submit data to be processed (e.g. from a HTML form) to an identified resource such as a file which is part of an application on a third party site. With a GET request, the submitted data is included as part of the URL. POST requests include the submitted data in the body of the request. An important principle of Web architecture is that all important resources be identifiable by a URI. A Uniform Resource Identifier (URI), is a compact string of characters used to identify or name a resource. The main purpose of this identification is to enable interaction with representations of the resource over a network, typically the World Wide Web, using specific protocols. URIs are defined in schemes defining a specific syntax and associated protocols. The finding discusses the relationship between the URI addressability of a resource and the choice between HTTP GET and POST methods with HTTP URIs. HTTP GET promotes URI addressability so, designers should adopt it for safe operations such as simple queries. POST is appropriate for other types of applications where a user request has the potential to change the state of the resource (or of related resources). The formatted GET or POST requests 406 are passed to web browser emulation software 408 and out of the SDUML module 306 to the persistent link module 308 and the third party site 310.

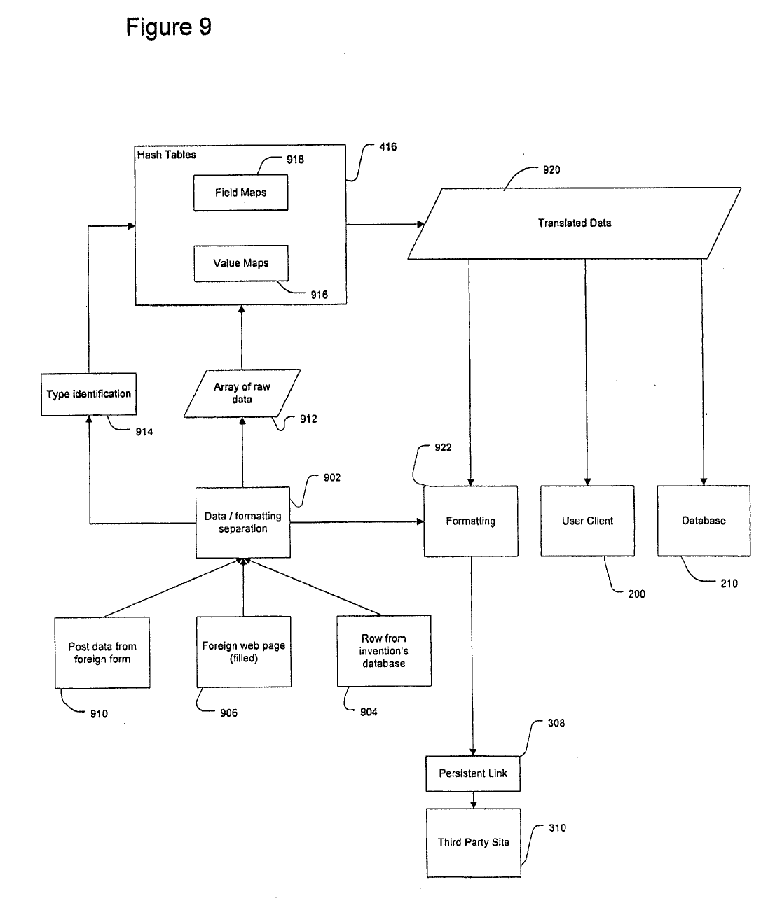

Hash tables 416 convert data stored on the server to the format used on the third party site 310 for which the request 346 is intended. The hash tables 416 are described in detail below with respect to FIG. 9.

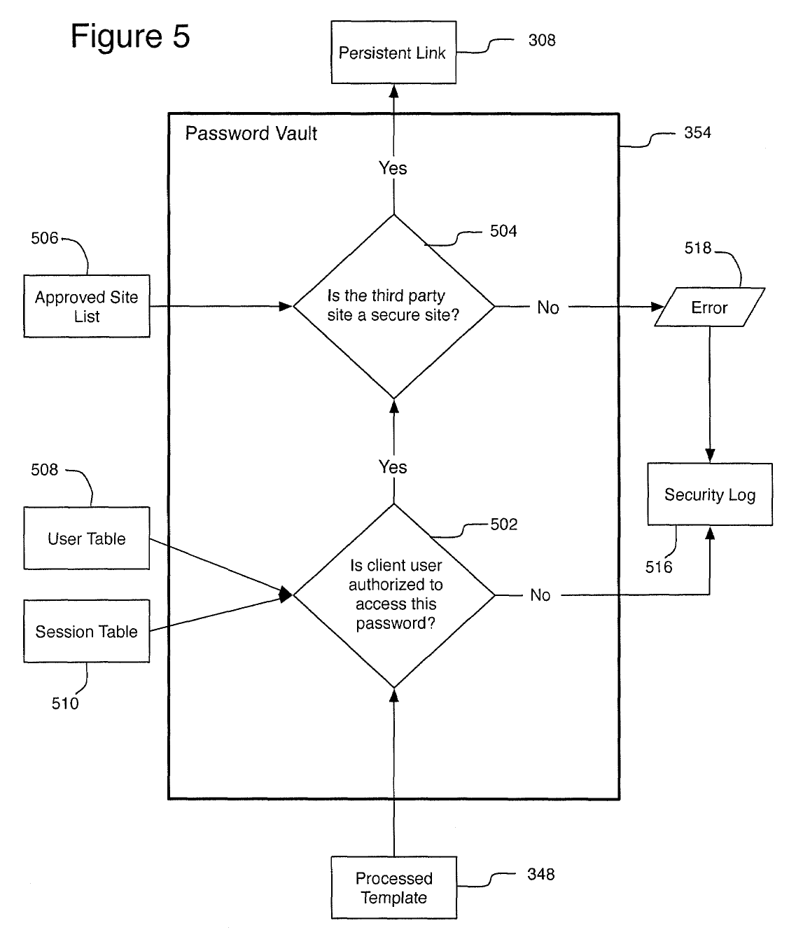

FIG. 5 is a detailed view of the password vault 354 which is contained within the server process 208. The password vault 354 receives the processed template 348 that requires a password to establish a connection to the third party site 310. The password vault 354 performs an analysis 502 to determine if the client 200 who initiated the template request is authorized to access the password that the template 348 is requesting. The password vault 354 accesses a user table 508 and session table 510 to make this determination. If the client 200 is not authorized to access the password, no password is provided and an error 518 is generated and stored in a security log 516.

After it is determined that the client 200 is authorized to access the password, the password vault 354 then performs an analysis to determine if the third party site is a secure site 504. An approved site list 506 is accessed to analyze whether or not the third party site 310 is a secure site. The approved site list 506 is contained in a database table. If the third party site 310 is not contained in the approved site list 506, no password is provided to the template 348 and the system generates the error 518 and the stores the error in the system log 516. If it is determined that the third party site 310 is a secure site, the password vault 354 provides the necessary password to the template 348 and the template 348 is passed to the persistent link 308 module with the correct password to establish a connection with the third party site 310.

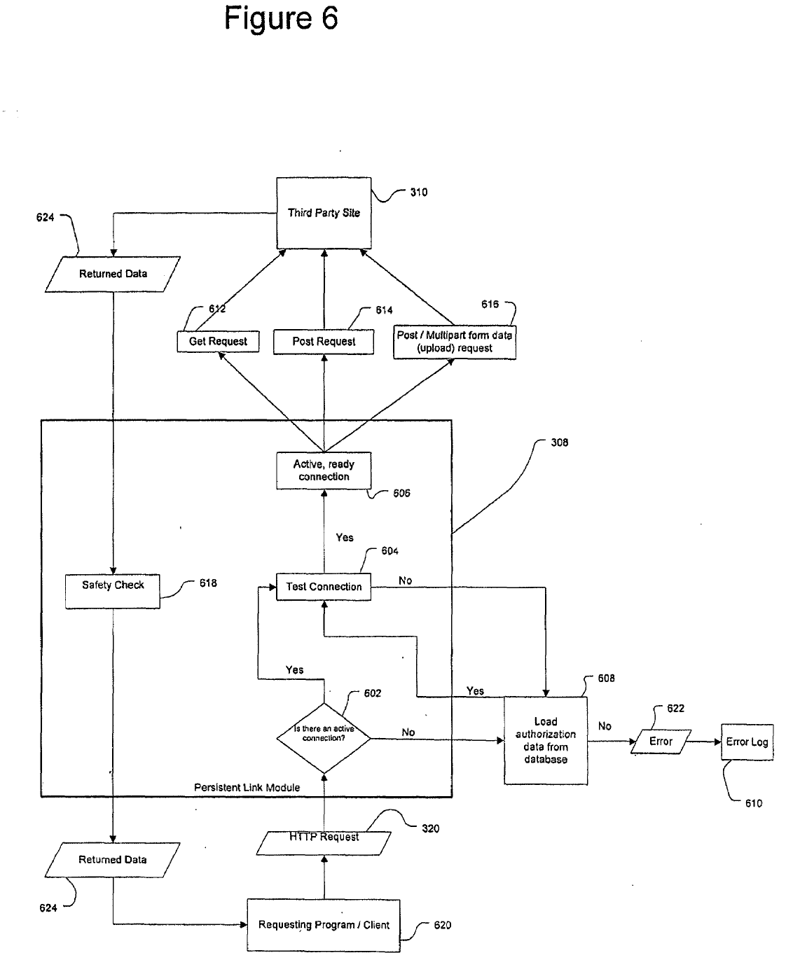

FIG. 6 is a detailed view of the persistent link 308 module. The persistent link 308 module activates after receiving an http request 320 from another subsystem within the system. The persistent link 308 module can also accept http requests directly from a web browser (not shown) to allow it to act as a proxy server.

The persistent link 308 module performs an analysis to determine the existence of a live connection to the third party site 310. If the persistent link module determines that a live connection to the third party site exists, that live connection will be re-used. If no live connection exists for a given third party site, the persistent link 308 module will access the database 21 0 to load authorization data from a database 608 required by the third party site. If the authorization data fails to load from the database, an error 622 is generated and stored in an error log 610.

If the authorization data is successfully loaded from the database, the persistent link module will test the connection to the third party site to ensure that the connection is working properly as shown in 602. If a test connection 604 fails, the error 622 is generated and is stored in the error log 610. If the test result is successful, an active, ready connection 606 is established.

Once the active connection 606 is established. The persistent link 308 module emulates a web browser to complete any type of http request including but not limited to GET requests 612, POST requests 614 or POST/multipart form data (upload) requests 616. The persistent link 308 module generates subsequent requests to deal with any redirections, javascript, or other web technologies. Once the final HTTP request has been delivered, the persistent link 308 module receives the return data from the third party site 310.

Before requested data 624 is returned to the user, the requested data 624 is passed through a minimal safety check 618. The safety check 618 filters executable files, known viruses, and pre-defined blocks of text.

Finally, the requested data 624 is returned to the originating subsystem or a client 620.

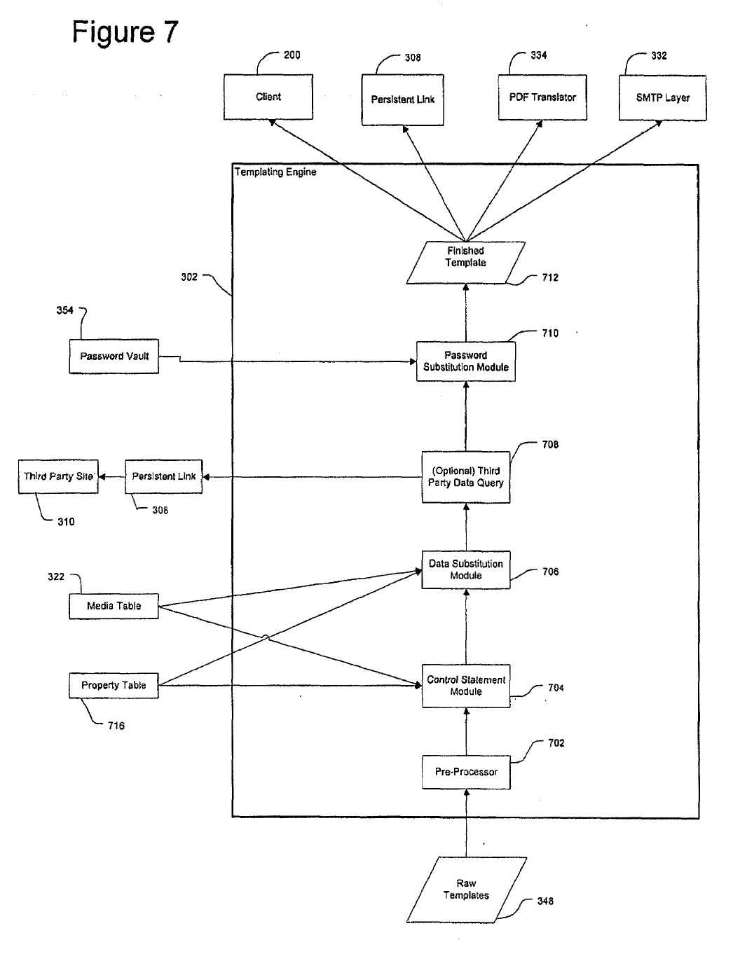

FIG. 7 is a detailed view of the templating engine 302. The templating engine 302 activates when it receives a raw, unprocessed template 348. The templates 348 are written in a simple markup language and can contain any kind of generic data, including the persistent link 308 instructions, as well as instructions on how to convert stored media and data into usable formats and arrangements such as web sites, web pages, or PDF files suitable for generating printed materials.

Code contained in a template 348 generates a web page. A pre-processor 702 removes any elements that simply require substitution, such as tags that substitute the server's 202 domain name or GET data. After the pre-processor, a control statement module 704 unrolls any control statements, such as conditionals or loops, substituting loop data inside each iteration. The media table 322 and property table 716 are referenced to substitute any necessary data within each iteration. The actual property data is substituted in a substitution module 706. During this process, the property table 716 and media table 322 may be referenced to substitute any necessary data. In the case of templates that describe connection protocols to third-party sites 310, the password vault 354 will be accessed by a password substitution module 710 to substitute passwords.

A finished template 712 can be transmitted to whoever needs it (or whatever subsystem it was supposed to go to). For example, the finished template 348 may be sent directly to the client 200, the finished template 712 may be sent to the PDF translator 334 to generate a PDF, the finished template 712 may be sent to the persistent link 308 module to be transmitted to the third party site 310 or the finished template 712 may be transmitted to the SMTP layer 332 to generate a customized email.

In an embodiment, the template may contain instructions for retrieving data from the third party site 310 to perform the necessary substitutions. In such cases, the Templating Engine 302 may perform an optional Third Party Data Query 708. The Third Party Data Query 708 uses the persistent link 308 module to retrieve data from the third party site 310 to be substituted into the template 348.

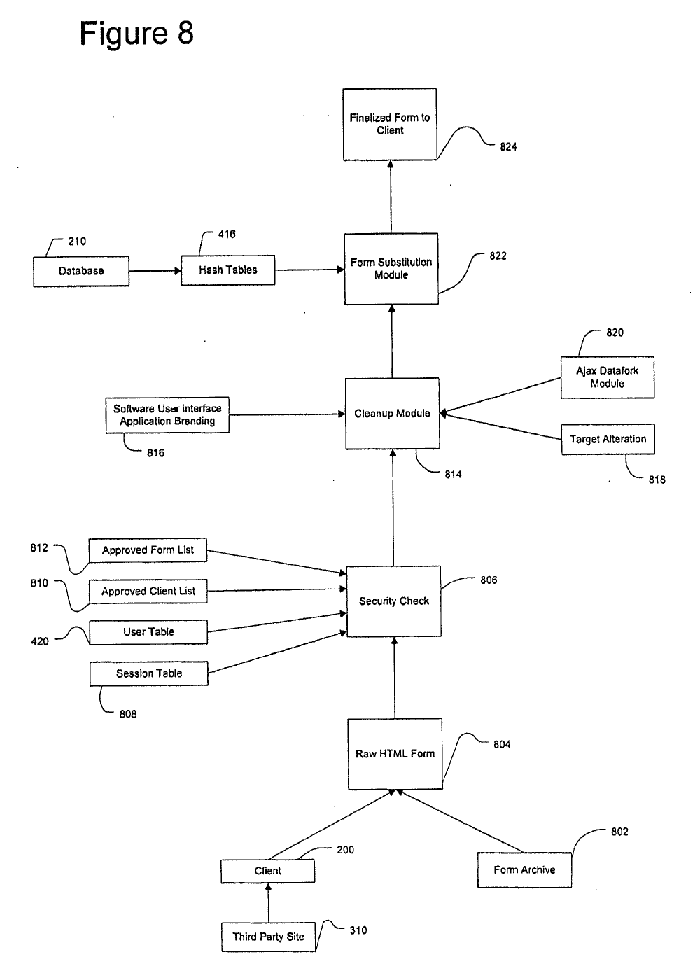

FIG. 8 is a detailed view of the auto fill component of the system. In an embodiment, the system receives a raw HTML form 804 from a browser plug-in 800 (which receives it from the client 200 who receives it directly from the third-party site 310). In an embodiment, the system receives a HTML form 804 from a local form archive 802. A local form archive is a storage mechanism for forms which the application saves to communicate with frequently accessed third party sites 310.

The system performs a security check 806 to determine if the system is authorized to disclose the property data to a) the client 200 user and b) the third party site 310 for which the auto-filled form is intended. Due to the fact that the client 200 transmits the data, the second check is useful for avoiding user error. The security check 806 accesses an approved form list 812, an approved client list 810, the user table 420 and the session table 808 to complete this security check 806.

The form passes through a cleanup module 814. The original form is modified to include several improvements including but not limited to: (1) the form is hidden and simplified to a single “Click here to send” button; (2) the form's target may be altered 818; (3) branding may be inserted 816; and (4) an ajax datafork module 820 inserts ajax code into the form to “fork” the form output to both the third-party site 310 and a server-side logging subsystem (not shown). The server side logging system uses a database to create a history of form submissions.

The form is passed to a form substitution module 822. The form substitution module 822 includes an algorithm that locates all of the form fields, removes any original pre-filled values, and replaces them with the data stored within the database 210 of the system. Hash tables 416 are used to ensure that new values contained in the fields will be compatible with the constraints of the third party site 310 contained in the form's target.

A finalized pre-filled form 824 is returned to the client 200, who simply submits the finalized pre- filled form to the third-party site 310.

FIG. 9 is a detailed view of the functions relating to the hash tables 416. The hash tables 416 provide a means for converting data from an original system to a format which is compatible with a different system or third party site 310. For example, the system synchronizes data contained in the database 210 with the third party sites 310. The system may contain the database 210 field named “association fee” with a value of 100. The third party site 310 may contain a database with a similar field named “condo fee” with the same value of 100. The hash tables 416 are used to convert the field name from “association fee” to “condo fee” before the data is sent to the third party site 310 to ensure that the data confirms to the design of the third party site's 310 database. Other modifications may also take place including, but not limited to, changing the size of the field or the data type.

Hash tables 416 accept data in different ways. Data can be sent as post data from a foreign form 910 including but not limited to, as a foreign web page 906 or as a row from a database contained in a system 904.

Once the data is received, the system performs a separation 902 of the data from formatting 922. For example, a web page of a list of data fields and values not only contains these data fields and values, but also contains other formatting 922 information relating to page layout and the appearance of the page. This formatting 922 information is separated and stored if necessary. Once the data is separated from the formatting 922, the data is converted to an array of raw data 912 and sent to the hash tables 416. Additionally, type identification 914 is sent to the hash tables 416. The type identification 914 includes information about the source and structure of the data. For example, the type identification may instruct the hash tables 416 that the data originated from or is destined for a specific third party site 310. The hash tables 416 will then use the field maps 918 and value maps 916 associated with that third party site 310 to perform the necessary translations.

The hash tables 416 contain both field maps 918 and value maps 916. The field maps 918 store associations between names used by third-party sites 310 and local names for a given piece of data. The value maps 916 perform the translations and minor alterations necessary to store data created on third-party sites 310 within the local database and vice versa. For example, a third-party site may store dates in YYYY-DD-MM format, whereas the local database might store date in MM-DD-YYYY format. In other cases, third-party sites may use alphabetical enumerations to store data, and the value maps would associate the letters with the local enumeration. The value maps 916 ensure that a given piece of data is consistent with the rules of the database intended to store the data.

Once the conversion is complete, translated data 920 is available for multiple uses. It can be sent directly back to the client 200. Additionally, translated data 920 can be sent to the database 210 or it can be re-combined with the original formatting 922 and sent to the third party site 310 via the persistent link 308 module.

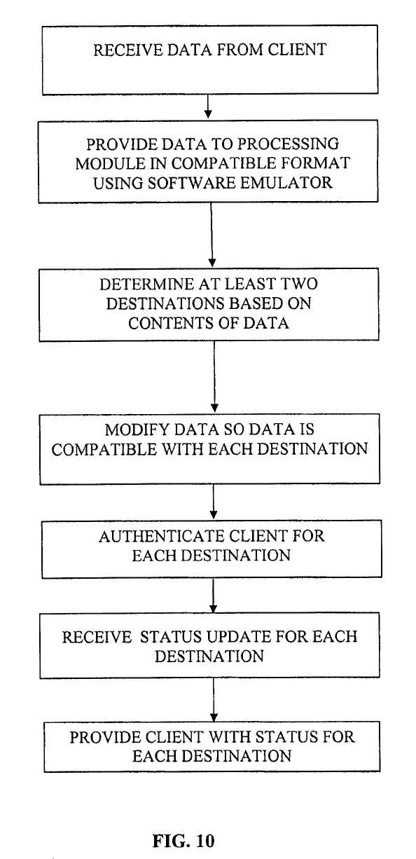

FIG. 10 is a flow diagram showing an embodiment of a method for updating a database record in multiple destinations. A method for updating a database record in multiple destinations includes receiving data and media from a client; providing the data and media to a processing module in a compatible format using a software emulator; determining at least two destinations based on the contents of the data and media; modifying the data and media so the data and media are compatible with each destination; authenticating the client for each destination using the processing module; sending the data and media in a compatible format to each destination; receiving a status update from each destination; and providing the client with a status for each destination.

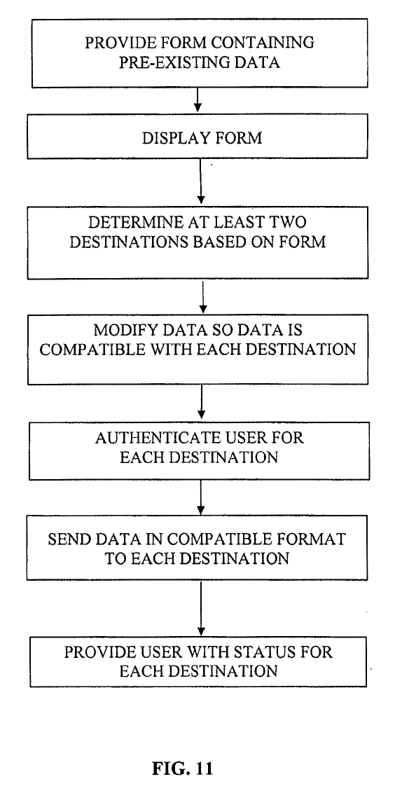

FIG. 11 is a flow diagram showing an embodiment of a method for updating a database record in multiple destinations. A method for updating a database record in multiple destinations includes providing a form containing pre-existing data and references to pre-existing media; displaying the form; determining at least two destinations based on the form; modifying the data and media so the data and media are compatible with each destination; authenticating the user for each destination; sending the data and media in a compatible format to each destination; and providing the user with a status for each destination.

The processing performed by the system described herein may be performed by a general purpose computer alone or in connection with a specialized processing computer. Such processing may be performed by a single platform or by a distributed processing platform. In addition, such processing and functionality can be implemented in the form of special purpose hardware or in the form of software being run by a general purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

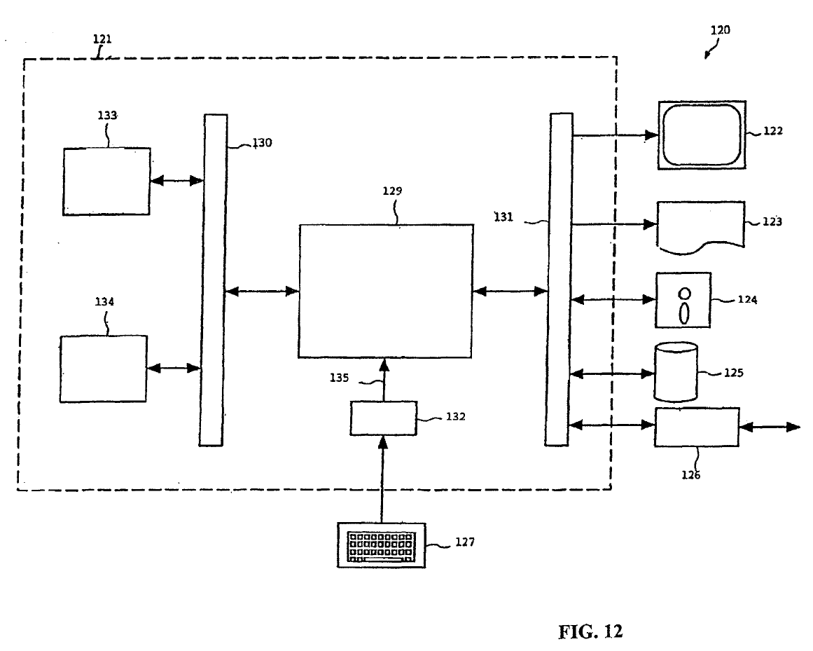

For example, a block diagram of a representative computer system 120 is shown in FIG. 12. In another embodiment of the present system, the computer system is an embedded computer system. The computer system 120 includes a computer 121, a display screen (or monitor) 122, a printer 123, a floppy disk drive 124, a hard disk drive 125, a network interface 126 and a keyboard 127. The computer 121 includes a microprocessor 129, a memory bus 130, a peripheral bus 131 and a keyboard controller 132. The keyboard 127 is used by a user to input commands and other instructions to the computer system 120. The keyboard controller 132 receives input from the keyboard 127 and sends decoded symbols for each pressed key of the keyboard 127 to the microprocessor 129 over a bus 135. The computer 121 can be a personal computer, a workstation or some other type of computer.

The microprocessor 129 controls the operation of the computer system 120. The microprocessor 129 uses instructions received from memory and outputs and displays the data on output devices. The keyboard 127 is used by a user to input commands and other instructions to the computer system 120. The memory bus 130 is used by the microprocessor 129 to access a random access memory (RAM) 133 and a read only memory (ROM) 134. The RAM 133 is used by the microprocessor 129 as a general storage area and the ROM 134 is used to store the instructions or program code followed by the microprocessor 129. The computer code and data may reside on the RAM 133, the ROM 134, the hard disk drive 125 or a removable program medium that can be loaded or installed on the computer system 120.

The peripheral bus 131 is used to access the input, output and storage devices used by the computer 121. These input, output and storage devices include, but are not limited to, the display screen 122 the printer 123, the floppy disk drive 124, the hard disk drive 125 and the network interface 126.

The display screen 122 displays images of the data provided by the microprocessor 129 via the peripheral bus 131 or provided by other components in the computer system 120. The printer 123 provides an image on a sheet of paper or a similar type of surface. Other output devices including, but not limited to, plotters or typesetters can be used in place of, or in addition to, the printer 123.

The floppy disk drive 124 and the hard disk drive 125 are used to store various types of data. The floppy disk drive 124 facilitates transporting the data to a separate computer system while the hard disk drive 125 allows fast access to large amounts of stored data. The network interface 126 is used to send and receive data over a network that is connected to other computer systems. Those skilled in the art will recognize that other persistent storage devices to store various types of data are known in the art and are within the spirit and scope of the presently disclosed embodiments.

A system for updating a database record in multiple destinations includes a form to receive data from a client and determine at least two destinations; a central server configured to receive and modify the data so the data is compatible with each destination; wherein the central server authenticates with each destination, sends the data in the form in a compatible format for each destination, and receives a status update from each destination; and wherein the central server is configured to provide the client with a status for each destination.

A system to update a database record in multiple destinations includes a central server configured to receive data and media from a client and determine at least two destinations, wherein the central server is configured to receive and modify the data and media so the data and media are compatible with each destination; an emulator configured to authenticate the central server with a third party site and send the data and media in a compatible format; wherein the central server is configured to receive a status update from each destination based on the data and media sent by the emulator; and wherein the central server is configured to provide the client with a status for each destination.

All patents, patent applications, and published references cited herein are hereby incorporated by reference in their entirety. While this system has been particularly shown and described with references to preferred embodiments thereof, it will be understood by those skilled in the art that various changes in form and details may be made therein without departing from the scope of the system encompassed by the appended claims.

What is claimed is:

1. A system for updating a database record in multiple destinations comprising:
a form to receive data from a client and determine at least two destinations;
a central server configured to receive and modify the data so the data is compatible with each destination;
wherein the central server authenticates with each destination, sends the data in the form in a compatible format for each destination, and receives a status update from each destination; and
wherein the central server is configured to provide the client with a status for each destination.

2. The system of claim 1 wherein the form is populated using pre-existing data and references to pre-existing media.

3. The system of claim 1 wherein the data includes data and media for real property listings of real estate.

4. The system of claim 1 further comprising a persistent link for storing a location for each destination.

5. The system of claim 1 further comprising a plugin configured to authenticate the client with each destination.

6. A system to update a database record in multiple destinations comprising:
a central server configured to receive data and media from a client and determine at least two destinations, wherein the central server is configured to receive and modify the data and media so the data and media are compatible with each destination;
an emulator configured to authenticate the central server with a third party site and send the data and media in a compatible format;
wherein the central server is configured to receive a status update from each destination based on the data and media sent by the emulator; and
wherein the central server is configured to provide the client with a status for each destination.

7. The system of claim 6 wherein the emulator uses POST, GET, or other suitable technology to send the data and media.

8. A method for updating a database record in multiple destinations comprising:
receiving data and media from a client;
providing the data and media to a processing module in a compatible format using a software emulator;
determining at least two destinations based on the contents of the data and media;
modifying the data and media so the data and media are compatible with each destination;
authenticating the client for each destination using the processing module;
sending the data and media in a compatible format to each destination;
receiving a status update from each destination; and
providing the client with a status for each destination.

9. The method of claim 8 wherein the at least two destinations contain data and media for real property listings of real estate.

10. The method of claim 8 further comprising accessing each destination using a persistent link software module.

11. The method of claim 8 wherein the software emulator uses POST, GET, or other suitable technology to send the data and media.

12. The method of claim 8 further comprising authenticating the client using a plugin.

13. The method of claim 8 further comprising providing to the client a form through a template engine.

14. A method for updating a database record in multiple destinations comprising:
providing a form containing pre-existing data and references to pre-existing media;
displaying the form;
determining at least two destinations based on the form;
modifying the data and media so the data and media are compatible with each destination;
authenticating the user for each destination;
sending the data and media in a compatible format to each destination; and
providing the user with a status for each destination.

15. The method of claim 14 wherein the form is a web page.

16. The method of claim 14 the data and media includes data and media for real property listings of real estate.

17. The method of claim 14 further comprising receiving a status update from each destination.

18. The method of claim 14 further comprising accessing each destination using a persistent link software module.

19. The method of claim 14 further comprising authenticating the user using a plugin.

20. The method of claim 14 further comprising providing the form through a template engine.
